(19) United States
(12) Patent Application Publication
(10) Pub. No.: US 2010/0308606 A1
(43) Pub. Date: Dec. 9, 2010

(54) SECURITY SEAL

(76) Inventor: André de Lima Castro, Rio de Janeiro (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/681,051

(22) PCT Filed: Oct. 8, 2008
(86) PCT No.: PCT/BR08/00303

§ 371 Date: Aug. 24, 2010

(30) Foreign Application Priority Data
Oct. 10, 2007 (BR) PI0703689-2

(51) Int. Cl. G09F 3/03; G09F 3/00

(52) U.S. Cl. 292/307 R; 40/299.01

(57) ABSTRACT

The invention refers to a security seal, especially of the type used in the transport of valuables or chemical/petroleum products, in drums, trucks, tankers, railway cars and the like, as well as in electrical equipment and doorways. The seal comprises a seal body (1) and a steel cord (2) fixed at one end to the body. In use, the free end is passed through the lements to be sealed and then introduced through a passage (7) through the body (1). The seal body (1) also has locking means associated with the passage (7) to prevent withdrawal of the steel cord (2). The body (1) may be personalized by the manufacturer to as to make the seal unique and thus with a high degree of security. So as further to increase the degree of security and to permit the user to introduce his own marking or personalisation, the invention provides for a transparent cover (4) which receives the seal body (1) as well an identification element which is inserted and locked into body (1) and, at the same time, locks the body (1) within the cover (4). The identification element may be, for example, a label (18) or an electronic chip (20) which may be identified from the exterior when the system is in the sealed configuration.

The present invention relates to security seals, especially, nut not exclusively, to the type used, for example, whenever it is necessary to use seals that exhibit both characteristics of high security and strength. Such seals may be used in the transport of valuables or of chemical/petroleum products, on drums, trucks, tankers, railroad cars and the like, as well as on electrical equipment and gateways.

### BACKGROUND OF THE INVENTION

Seals of the above type include the so-called “cable seals”. One example is the Cable Seal X187CB09CS manufactured by ELC Produtos de Segurança Indústria e Comércio Ltda which may be visualized at http://elc.com.br/portugues/site/metalacre.php. This seal comprises a seal body with a steel cord having one free end and another end fixed to the seal body. In use, the free end is passed through the members to be sealed (for example, the handles of the door of a railroad truck) and then introduced into a passage that passes through the seal body. The seal body includes internal locking means associated with the passage so as to prevent withdrawal of the steel cord.

With a view to guaranteeing the degree of security provided by the seal, during the manufacturing process an outer face of its body is laser engraved with an individual identification, such as a sequential number with or without a bar code or the like, the seal further being able to be personalized with the logo or another identifier of the purchaser of the seal. This obviously serves to prevent unauthorized third parties from obtaining access to the interior of the sealed object or vehicle and then substituting the seal with an identical one. It is normal practice, on applying the seal, to note the number thereof and to inform such number to the person at the destination so that he can check prior to opening that the seal is intact and its number unaltered.

### OBJECTS OF THE INVENTION

Although the above seals are very efficient, there are occasions in which the user, especially in the transport of valuables (money), has an even greater than usual preoccupation regarding security and this is due to the fact that the factory numbering is not under his control whereby there is a possibility—even if remote—of an employee of the manufacturer duplicating seal numbers. This naturally would permit an unauthorised person to destroy the seal in use and to substitute it after opening an armoured car or the like.

An object of the present invention is to allay such a worry with regards to greater security by means of a seal that totally eliminates the drawback indicated above with respect to the prior art seals.

### SUMMARY OF THE INVENTION

The present invention therefore refers to a security seal of the known type that comprises a seal body and an elongated member having a first end fixed to the body and a second free end. Opened through the body, there is a passage for the free end of the elongated element and locking means associated with the passage serve to prevent withdrawal of the elongated element once introduced through the passage.

According to the invention, the seal is characterized by comprising an outer cover that has one open and is adapted to receive the seal body in its interior, the opposite end of the cover preventing removal of the seal body therethrough. In interior of the cover is provided with first locking means in a region not occupied by the seal body when this latter is received within the cover.

In addition and further in accordance with the invention, there is a separate identification element adapted to be received through the open end of the cover in the said region not occupied by the seal body, which is provided with second locking means cooperable with the first locking means so as to prevent removal of the identification element after insertion in the cover to a locked position. The identification element is configured such that, in its locked position, it prevents withdrawal of the seal body through the said open end of the cover and the cover has at least one transparent region that permits viewing, from outside, of an identification region on the identification element.

This new seal permits the user, in the identification region, to place, stick or in any other way retain a paper, chip or the like provide with an identification number, a bar code, electronic information or the like that is chosen solely by him and thus under his control. When the seal is locked with the seal body within the cover and retained there on insertion and consequent locking of the identification element, such personal user identification will be visible through the transparent region of the cover. In the case, which is most recommended, that the manufacturer has also individualized the seal body (as presently occurs with the prior art seal described above) and the cover is totally transparent or at least has another transparent region, the closed seal will provide two individualized identifications, one of the manufacturer and one of the user. This further increases the degree of security offered to the user, thus allaying his present worries and fully meeting his requirements.

In the presently preferred embodiment of the seal, the identification element comprises a blade with a flange at one end, the flange closing the open end of the cover when the element is in its locked configuration within the cover. Furthermore, the first locking means may comprise at least one and preferably two inner shoulders which, on passing complimentary shoulders in the cover, catch behind the latter to prevent withdrawal of the identification element.

It is also preferable that, in the locked configuration of the identification element, its identification area is immediately subjacent the transparent region of the cover. This identification area may advantageously be recessed in the blade of the identification element.

In the preferred embodiment, the cover is totally transparent and may advantageously be made of polycarbonate.

As in the prior art seal mentioned and when high strength is required, the elongated element of the seal may be a metal wire or cord.

### BRIEF DESCRIPTION OF THE DRAWINGS

The present invention will now be descried in more detail, but only by way of example, with reference to the accompanying drawings, in which:

FIG. 1 is a perspective view of the component parts of the presently preferred embodiment of the present invention, immediately prior to use;

FIG. 2 is a perspective view of the seal during the closure phase

FIG. 3 is a perspective view of the already closed seal, illustrating the personalized and individualised user identification;

FIG. 4 is a perspective view of the other side of the closed seal, illustrating the personalized and individualised manufacturer identification;

FIG. 5 is a perspective view of an alternative identification element and an alternative identification means in the form of an electronic chip.

### DETAILED DESCRIPTION OF THE DRAWINGS

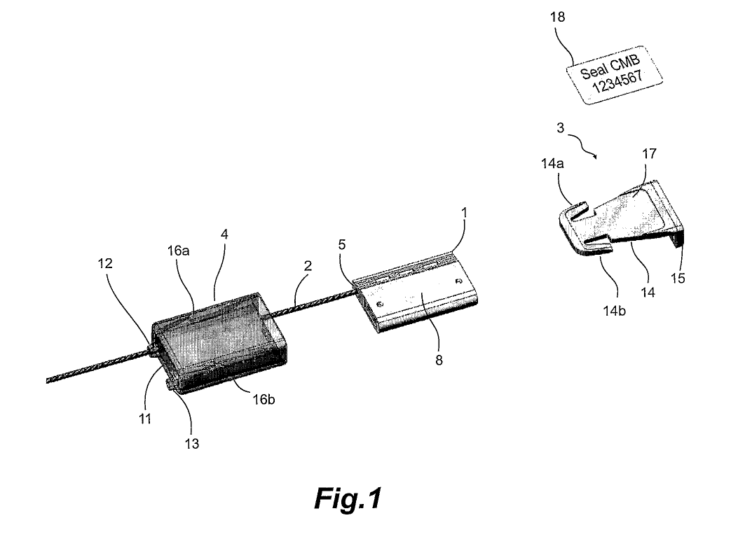

FIG. 1 shows the presently preferred first embodiment of the present invention, in the form of a security seal comprising a seal body 1, a steel cord 2, an identification element 3 and a transparent polycarbonate cover 4.

For all intents and purposes, seal body 1 and steel cord 2 are identical to the prior art seals mentioned above. For heavy service, cord 2 is a galvanised steel cord comprising seven 2.00 mm filaments, its length being whatever is suitable for the use specified by the user. Body 1 of the seal is made 85% SCR and 15% PSAI plastic.

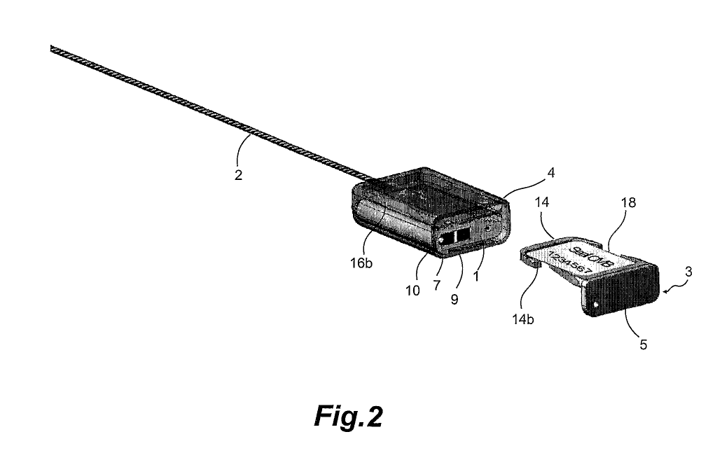

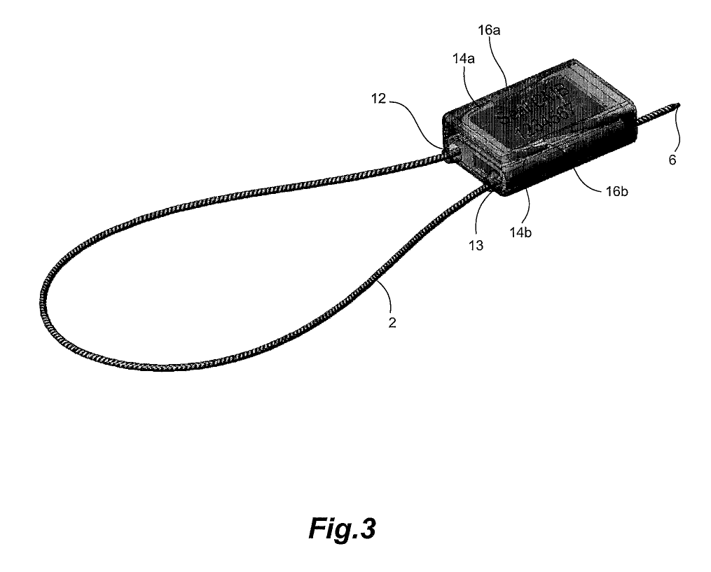

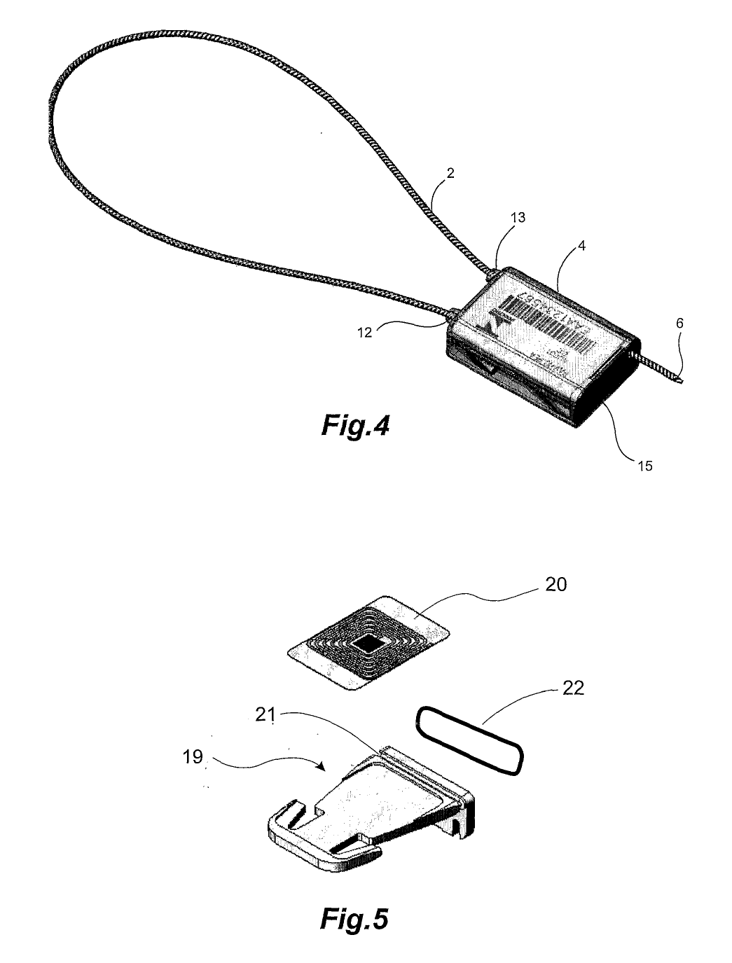

As can be seen from the drawings, one end 5 of the steel cord 2 is anchored in the interior of body 1 and the other end 6 is free, not shown in FIGS. 1 and 2, but visible in FIGS. 3 and 4, after closure of the seal. Body 1 of the seal, on its side opposite the location where end 5 of cord 2 is anchored, is formed with an internal passage 7 extending between the two ends of the body. Internally, body 1 is provided with a metallic closure or locking mechanism associated with internal passage 7 which permits free passage of the cord when the free end 6 is inserted into internal passage 7, but prevents its withdrawal in the opposite direction by means of a wedging action. The locking mechanism, which is internal, is not illustrated in the drawings since it is well known and already used in the prior art Cable Seal mentioned above and, furthermore, is not in any way related to the novel features of the present invention.

As can be seen in FIG. 1, a larger face 8 of seal body 1 é substantially smooth and does not carry any marking. The opposite face, visible in FIG. 4, however, carries a laser engraving applied during manufacture, which includes a number and a bar code which serve to individualise the seal which is thus unique.

The security seal described up to this point and which comprises body 1 with its laser engraving and cord 2 is part of the state of the art.

According to the present invention and as mentioned above, there are two more components, that is to say, the transparent polycarbonate cover 4 and the identification element 3. Cover 4 is shaped to receive seal body 1 between the inner surface of an outer wall 9 and an internal dividing wall 10. On end of cover 4 is open to receive seal body 1 and its other end is closed, with the exception of two small openings 12 and 13 for the passage of cord 2.

Dividing wall 10 separates the inside of cover 4 into a housing for receiving the seal body 1 and a smaller housing for receiving a blade portion 14 of the identification element 3. Element 3 comprises blade 14 and an end flange 15 which is normal to the blade. At its inner end blade 14 has an anchor configuration provided with two flexible side arms 14a and 14b which interact with respective internal shoulders within seal body 1, above dividing wall 10. The shoulders define stop surfaces 16a and 16b (see FIG. 3) so that, when blade 14 is inserted into body 1, above dividing wall 10, flexible arms 14a and 14b are deformed on passing the shoulder so that, on expanding again, the become caught behind stop surfaces 16a and 16b (see FIG. 3). With identification element 3 thus inserted and locked within cover 4, flange 15 closes the open end of the cover, thus preventing removal of seal body 1.

Blade 14 of identification element 3 is slightly recessed in its upper surface so as to define an identification region 17.

Finally, when the user desires to introduce his own personalised identification of the seal, he can stick or place any type of label 18 or the like in the identification region 17 on blade 14.

The procedure for using the seal is as follows, starting from the situation shown in FIG. 1:

1. Steel cord 2 has already been passed through seal body 1, through the inside of cover 4 and out of opening 12 (FIG. 1);

2. Label 18 is placed on the identification region 17 of blade 14 of the identification element 3 (FIG. 1);

3. Cord 2 is pulled to accommodate seal body 1 totally within transparent cover 4 (FIG. 2);

4. The blade 14 of the identification element is inserted into cover 4 until its anchor is caught behind stop surfaces 16a and 16b, flange 15 closing body 1 within cover 4. At this moment, the seal is complete and ready for use, it being observed that both the individualised user marking (label 18 and FIG. 3) and the individualized manufacturer marking (FIG. 4), although inaccessible, may be visualized through the transparent walls of cover 4.

5. The seal may now be closed (sealed) by passing cord 2 through openings in the object to be sealed (not shown in the drawings), opening 13 in cover 4 and internal passage 7 in seal body 1, its free end 6 then being pulled to the desired position, it being locked in that position by means of the metallic locking mechanism within the seal body (FIGS. 3 and 4).

The specific materials mentioned above are not limiting since any suitable material may be used. In addition, if the user considers sufficient security to be obtained by using only his own personalisation (label 18), there would be no need to have manufacturer applied personalisation as well, making the seal less expensive. In such a case, it would be sufficient for only the region of cover 4 above the identification region 17 and label 18 to be transparent. On the other hand, in order to ensure a greater degree of security, it is obviously preferable to have an indelible factory marking (laser engraving, for example) together with the user personalisation of the seal so as to provide double security.

In particular, FIG. 5 shows a slightly modified identification element 19 and, instead of the label 18 of FIGS. 1 to 4, an electronic identification chip 20 containing information that, apart from personalisation of the seal could also include other information regarding the use of the seal, the nature, quality or the like of the object or product being sealed and so on. It is to be noted that, in the case of using an electronic chip 20, the cover 4 would not necessarily have to be transparent in the region of the chip provided that the chip could be identified/read electronically through the material of the cover.

Identification element 19 is almost identical to element 3 except that it is formed with a groove 21 for receiving an O-ring seal 22 adjacent flange 5. When the seal is used with identification element 19, O-ring seal 22 ensures that the housing or compartment that receives element 19 is hermetically sealed. This prevents humidity or liquids from reaching the interior of the compartment and protects the chip 20, label 18 or the like from malfunction or damage. In addition, if the hermetically closed compartment were to contain a liquid or chemical product used to identify a property, use or specific condition of the seal, that product (for instance, a liquid that changes colour) could be contained safely within the seal.

Other modifications within the spirit and basic concept of the present invention and obvious to a person versed in the art after a consideration of the present specification should be considered to be within the scope of the invention, as defined in the following claims.

1-10. (canceled)

11. A security seal comprising:
a seal body (1) and an elongated member (2) having a first end (5) fixed to the body and a second free end (6), said body (1) being formed there through with a passage for the free end (6) of the elongated element (2) and locking means associated with the passage (7) to prevent withdrawal of the elongated element once introduced through the passage (7); and
an outer cover (4) that has one open end adapted to receive the seal body (1) through said open end in its interior, the opposite end of the cover (4) preventing removal of the seal body therethrough;
characterized by further comprising:
first locking means (16a, 16b) provided in the interior of said cover (4), said first locking means (16a, 16b) being in a region not occupied by the seal body (1) when this latter is received within the cover (4); and
a separate identification element (3; 19) adapted to be received through said open end of the cover (4) in the said region not occupied by the seal body (1), which is provided with second locking means (14a, 14b) cooperable with said first locking means (16a, 16b) so as to prevent removal of the identification element (3; 19) after locking by insertion in the cover (4), wherein:
said identification element (3; 19) is provided with an identification region (17) adapted to receive identification means (18; 20) and is configured such that, in its locked position, it prevents withdrawal of the seal body through the said open end of the cover, said identification means (18; 20) being identifiable from outside said cover when said identification element is in the locked position.

12. The security seal according to claim 11, characterized in that said cover (4) has at least one transparent region that permits viewing, from outside, of said identification region (17) on the identification element (3; 19).

13. The security seal according to claim 11, characterized in that said identification element (3; 19) comprises a blade part (14) with a flange (15) at one end, said flange (5) closing the open end of said cover (4) when the identification element (3; 19) is locked in said cover (4).

14. The security seal according to claim 13, characterized in that said first locking means comprise at least one internal shoulder (16a, 16b) within said cover (4) and said second locking means comprise at least one flexible arm (14a, 14b) on said blade part (14) which, on passing said at least one shoulder (16a, 16b), is caught there behind to prevent withdrawal of said identification element (3; 19).

15. The security seal according to claim 14, characterized in that a region of said blade part (14) adjacent said flange (15) is provided with a peripheral groove (21) for receiving a sealing ring (22) to produce a seal that maintains said identification element (19) hermetically sealed from the outside once locked in said cover (4).

16. The security seal according to claim 15, characterized in that said identification region (17) is a region recessed in said blade part (14).

17. The security seal according to claim 16, characterized by further comprising identification means (18; 20) adapted to be received in said identification region (17) of said identification element (3; 19).

18. The security seal according to claim 17, characterized in that said identification means comprises a label (18).

19. The security seal according to claim 17, characterized in that said identification means comprises an electronic chip (20).

20. The security seal according to claim 19, characterized in that said seal body (1) is provided with a permanent individual marking visible from the outside through a transparent area of said cover (4) when the seal body is received therein.
